(19) United States
(12) Patent Application Publication
(10) Pub. No.: US 2025/0174041 A1
(43) Pub. Date: May 29, 2025

(54) IMAGE PROCESSING DEVICE AND OPERATION METHOD THERE OF

(71) Applicant: SOGANG UNIVERSITY RESEARCH & BUSINESS DEVELOPMENT FOUNDATION, Seoul (KR)

(72) Inventors: Hyung Min PARK, Seoul (KR); Young Hu PARK, Seoul (KR); Rae Hong PARK, Seoul (KR)

(21) Appl. No.: 18/944,173

(22) Filed: Nov. 12, 2024

(30) Foreign Application Priority Data
Nov. 27, 2023 (KR) 10-2023-0166915

(51) Int. Cl. G06V 40/16; G06V 10/24; G06V 10/26; G06V 10/762

(52) U.S. Cl. CPC G06V 40/165; G06V 10/245; G06V 10/26; G06V 10/762; G06V 40/171

(57) ABSTRACT

The image processing device according to the present disclosure may more quickly and accurately identify the meaning that a speaker intends to convey by grouping a plurality of input images into bundles of a group size corresponding to a certain size and then deriving feature data corresponding to lip shapes included in the plurality of input images based on a patch image obtained by dividing each of the plurality of input images into a patch size corresponding to the certain size.

### TECHNICAL FIELD

The present disclosure relates to an image processing device and an operation method thereof.

### BACKGROUND ART

In order to accurately recognize the meaning of sound conveyed by a speaker, not only voice data but also image data may be used. Recently, various researches in this regard have been conducted to identify the meaning that the speaker intends to convey using images.

### PRIOR ART DOCUMENT

### Patent Document

(Korean Patent Registration) No. 10-2602319 [symbol] (Registration Date: 2023 Nov. 16)

### DISCLOSURE

### Technical Problem

An object of the present disclosure is to provide an image processing device capable of more quickly and accurately identifying the meaning that a speaker intends to convey by grouping a plurality of input images into bundles of a group size corresponding to a certain size and then deriving feature data corresponding to lip shapes included in the plurality of input images based on a patch image obtained by dividing each of the plurality of input images into a patch size corresponding to the certain size.

### Technical Solution

According to an embodiment of the present disclosure, an image processing device may include an image conversion unit and a correction unit. The image conversion unit may provide feature data corresponding to lip shapes included in a plurality of input images based on a patch image obtained by dividing each of the plurality of input images into a patch size corresponding to a certain size. The correction unit may provide correction data by correcting the feature data.

In an embodiment, the image conversion unit may include an image providing unit and a data providing unit. The image providing unit may group the plurality of input images as a group size corresponding to the certain size, and then divide each of group images into the patch size to provide the patch image. The data providing unit may provide the feature data corresponding to the lip shapes based on the patch image.

In an embodiment, each of the bundles of the input images may overlap by the number of overlaps corresponding to a certain number.

In an embodiment, the number of overlaps may be ⅓ or more of the group size.

In an embodiment, the number of overlaps may increase as the number of the plurality of input images increases.

In an embodiment, each of the plurality of input images may be divided into a plurality of windows smaller than the patch size.

In an embodiment, the image processing device may further include a lip region detection unit. The lip region detection unit may detect a lip region occupied by a lip in each of the plurality of input images.

In an embodiment, the image processing device may further include a window calculating unit. The window calculating unit may calculate the number of the windows corresponding to the lip region of each of the plurality of input images.

In an embodiment, the image processing device may further include a determining unit. The determining unit may determine the patch size based on the number of the windows corresponding to the lip region.

In an embodiment, the patch size may be determined as a sum of an average value of the number of the windows corresponding to the lip region and half of the average value.

In an embodiment, the data providing unit may include a shift unit and a data output unit. The shift unit may provide a shift image generated by shifting the patch image by a unit window corresponding to each of the windows. The data output unit may provide the feature data based on the shift image.

In an embodiment, inputs of the data providing unit may correspond to the patch image of each of the plurality of input images.

According to an embodiment of the present disclosure, an image processing system may include an image conversion unit and an information unit. The image conversion unit may group each of a plurality of input images into bundles of a certain size and then provide feature data corresponding to lip shapes included in the plurality of input images based on a patch image obtained by dividing each of the plurality of input images into a patch size corresponding to the certain size. The information unit may provide meaning information corresponding to a meaning corresponding to the feature data.

According to an embodiment of the present disclosure, an operation method of an image processing device may include grouping, by an image conversion unit, each of a plurality of input images into bundles of a certain size and then provide feature data corresponding to lip shapes included in the plurality of input images based on a patch image obtained by dividing each of the plurality of input images into a patch size corresponding to the certain size, and providing, by a correction unit, correction data by correcting the feature data.

According to an embodiment of the present disclosure, an operation method of an image processing system may include grouping, by an image conversion unit, each of a plurality of input images into bundles of a certain size and then provide feature data corresponding to lip shapes included in the plurality of input images based on a patch image obtained by dividing each of the plurality of input images into a patch size corresponding to the certain size, and providing, by an information unit, meaning information corresponding to a meaning corresponding to the feature data.

In addition to the technical problems of the present disclosure mentioned above, other features and advantages of the present disclosure are described below or may be clearly understood by one of ordinary skill in the art to which the present disclosure belongs from such description and explanation.

### Advantageous Effects

As set forth above, the present disclosure has the following effects.

The image processing device according to the present disclosure may more quickly and accurately identify the meaning that a speaker intends to convey by grouping a plurality of input images into bundles of a group size corresponding to a certain size and then deriving feature data corresponding to lip shapes included in the plurality of input images based on a patch image obtained by dividing each of the plurality of input images into a patch size corresponding to the certain size.

In addition, other features and advantages of the present disclosure may be newly discovered through embodiments of the present disclosure.

### DESCRIPTION OF DRAWINGS

FIG. 1 is a diagram illustrating an image processing device according to embodiments of the present disclosure.

FIG. 2 is a diagram illustrating an image conversion unit included in the image processing device of FIG. 1.

FIG. 3 is a diagram illustrating an example of an input image used in the image processing device of FIG. 1.

FIG. 4 is a diagram illustrating a lip region detection unit included in the image processing device of FIG. 1.

FIG. 5 is a diagram illustrating a window calculating unit included in the image processing device of FIG. 1.

FIG. 6 is a diagram for explaining the lip region detection unit and the window calculating unit included in the image processing device of FIG. 1.

FIGS. 7 and 8 are diagrams for explaining a determining unit included in the image processing device of FIG. 1.

FIGS. 9 to 12 are diagrams for explaining an operation of a data provider included in the image processing device of FIG. 1.

FIG. 13 is a diagram for explaining inputs of the data provider included in the image processing device of FIG. 1.

FIG. 14 is a diagram for explaining grouping with an overlap included in the image processing device of FIG. 1.

FIG. 15 is a diagram illustrating an image processing system according to embodiments of the present disclosure.

FIG. 16 is a flowchart illustrating an operation method of an image processing device according to embodiments of the present disclosure.

FIG. 17 is a flowchart illustrating an operation method of an image processing system according to embodiments of the present disclosure.

### BEST MODE FOR INVENTION

In adding reference numerals to the components of each drawing herein, it should be noted that only the same components are given the same numerals as possible even if they are indicated in different drawings.

On the other hand, the meaning of the terms herein should be understood as follows.

Singular expressions should be understood as including plural expressions unless clearly defined differently in the context, and the scope of rights should not be limited by these terms.

The terms such as “include” or “have” should be understood not to preclude the existence or addition of one or more other features or numbers, steps, actions, components, parts, or combinations thereof.

Hereinafter, preferred embodiments of the present disclosure designed to solve the above problem are described in detail with reference to the accompanying drawings.

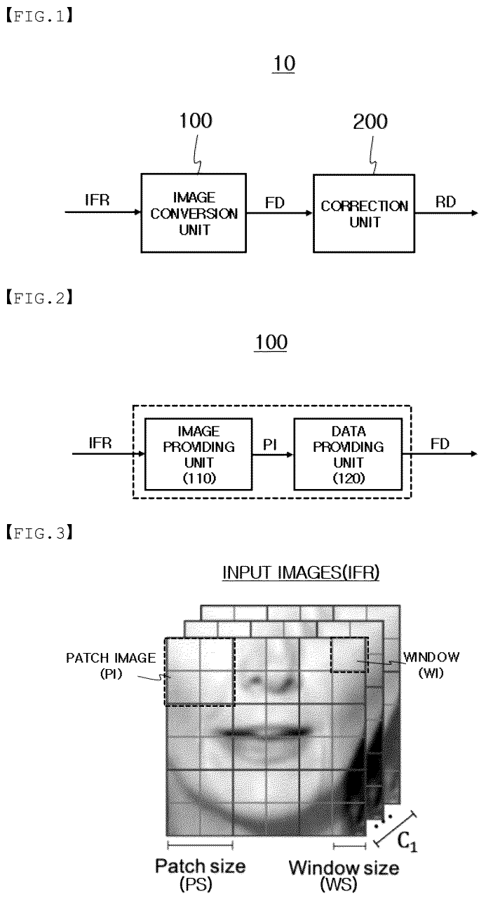

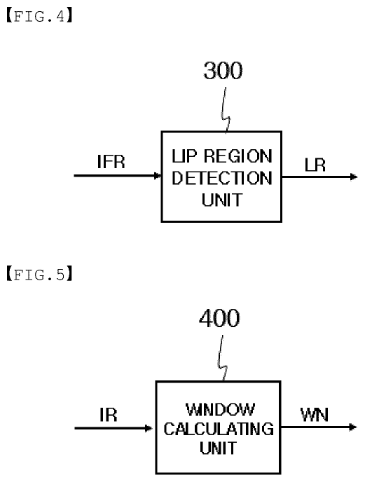

FIG. 1 is a diagram illustrating an image processing device according to embodiments of the present disclosure. FIG. 2 is a diagram illustrating an image conversion unit included in the image processing device of FIG. 1. FIG. 3 is a diagram illustrating an example of an input image used in the image processing device of FIG. 1.

Referring to FIGS. 1 to 3, an image processing device 10 according to an embodiment of the present disclosure may include an image conversion unit 100 and a correction unit 200. The image conversion unit 100 may provide feature data FD corresponding to lip shapes included in a plurality of input images IFR based on a patch image PI obtained by dividing each of the plurality of input images IFR into a patch size PS corresponding to a certain size.

In an embodiment, the image conversion unit 100 may include an image providing unit 110 and a data providing unit 120. The image providing unit 110 may group the plurality of input images IFR as a group size GS, and then divide each of group images GFR into the patch size PS to provide the patch image PI.

The image providing unit 110 may group the plurality of input images IFR as the certain group size GS to provide the group images GFR. In this case, the total utterance length is reduced compared to the input images IFR, and thus faster data processing may be performed. The plurality of group images GFR may process each of the input images IFR grouped using a depthwise separable convolutional neural network through an individual filter. Here, a convolution operation may be performed as a parallel operation of a graphic card.

In another embodiment, each of the plurality of input images IFR and the group images GFR may be divided into a plurality of windows WI smaller than the patch size PS. For example, the plurality of input images IFR may include a first input image IFR1 to an Nth input image IFRN. The first input image IFR1 may be divided into the plurality of windows WI. The plurality of windows WI may include first to thirty-sixth windows, and the patch size PS may be the size of four windows configured in a square shape. In this case, the first input image IFR1 may be divided into the patch sizes PS configured as four windows WI to implement nine patch images PI.

The data providing unit 120 may provide the feature data FD corresponding to lip shapes based on the patch image PI. Here, the data providing unit 120 may include a Swin transformer, and the data providing unit 120 may provide the feature data FD from the patch image PI by using the Swin transformer.

The correction unit 200 may correct the feature data FD to provide correction data RD. For example, the correction unit 200 used herein may include a conformer, which is mainly used in voice processing, but may also be applied to an image processing field according to the present disclosure.

The image processing device 10 according to the present disclosure may more accurately identify the meaning that a speaker intends to convey by deriving the feature data FD corresponding to the lip shapes included in the plurality of input images IFR based on the patch image PI obtained by dividing each of the plurality of input images IFR into the patch size PS corresponding to the certain size.

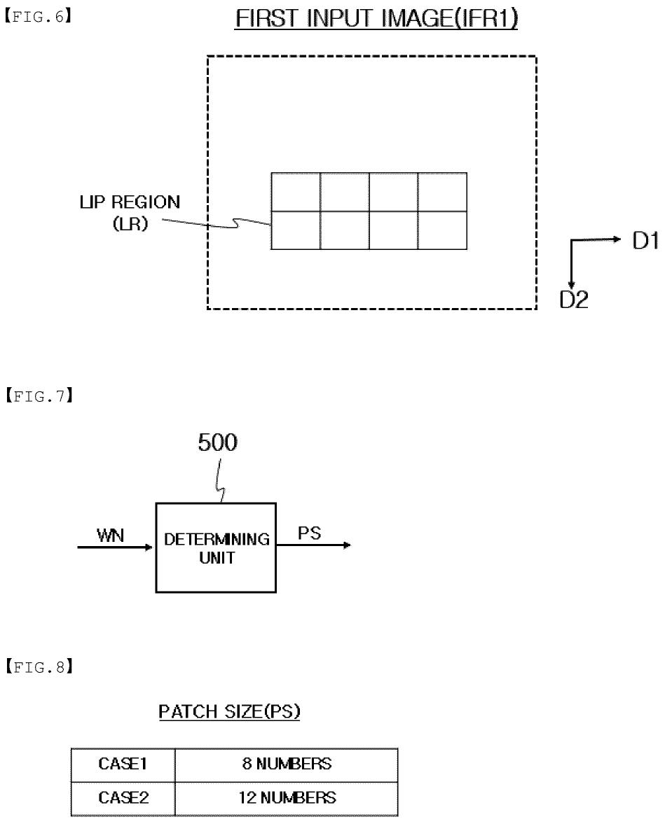

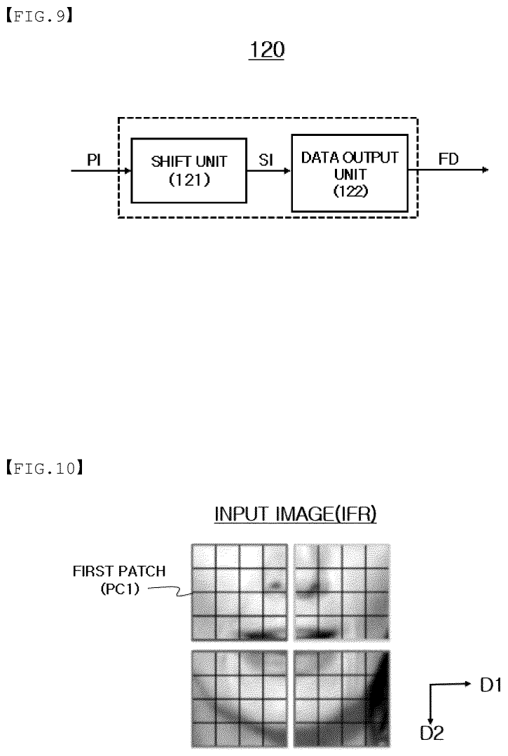

FIG. 4 is a diagram illustrating a lip region detection unit included in the image processing device of FIG. 1. FIG. 5 is a diagram illustrating a window calculating unit included in the image processing device of FIG. 1. FIG. 6 is a diagram for explaining the lip region detection unit and the window calculating unit included in the image processing device of FIG. 1. FIGS. 7 and 8 are diagrams for explaining a determining unit included in the image processing device of FIG. 1.

Referring to FIGS. 1 to 8, in an embodiment, the image processing device 10 may further include a lip region detection unit 300. The lip region detection unit 300 may detect a lip region LR occupied by a lip in each of the plurality of input images IFRs. For example, the plurality of input images IFRs may include the first to sixteenth input images IFR1 to IFR16. In this case, the lip region detection unit 300 may detect a lip part of a person included in each of the first to sixteenth input images IFR1 to IFR16 to provide the lip region LR including the lip of the person.

In an embodiment, the image processing device 10 may further include a window calculating unit 400. The window calculating unit 400 may calculate a number WN of the windows WI corresponding to the lip region LR of each of the plurality of input images IFR. For example, the lip region LR included in the first input image IFR1 among the plurality of input images IFR may be shown as in FIG. 6. Here, the lip region LR included in the first input image IFR1 may be calculated as 8 based on the number WN of the windows WI. In the same manner, the window calculating unit 400 may calculate the number WN of the windows WI corresponding to the lip regions LR included in second to sixteenth input images IFR16.

In an embodiment, the image processing device 10 may further include a determining unit 500. The determining unit 500 may determine the patch size PS based on the number WN of the windows WI corresponding to the lip region LR.

In an embodiment, the patch size PS may be determined as a sum of an average value of the number WN of the windows WI corresponding to the lip region LR and half of the average value. For example, the average value of the number WN of the windows WI corresponding to the lip regions LR included in the first input image IFR1 to the sixteenth input image IFR16 may be 8. In this case, the patch size PS may be 8+4=12 which is the sum of the average value of the number WN of the windows WI and half of the average value. This is a method of determining the patch size PS, and in addition, the patch size PS may be also determined with respect to a length in the first direction D1 corresponding to a greater value between a length of the lip region LR in a first direction D1 and a length of the lip region LR in a second direction D2.

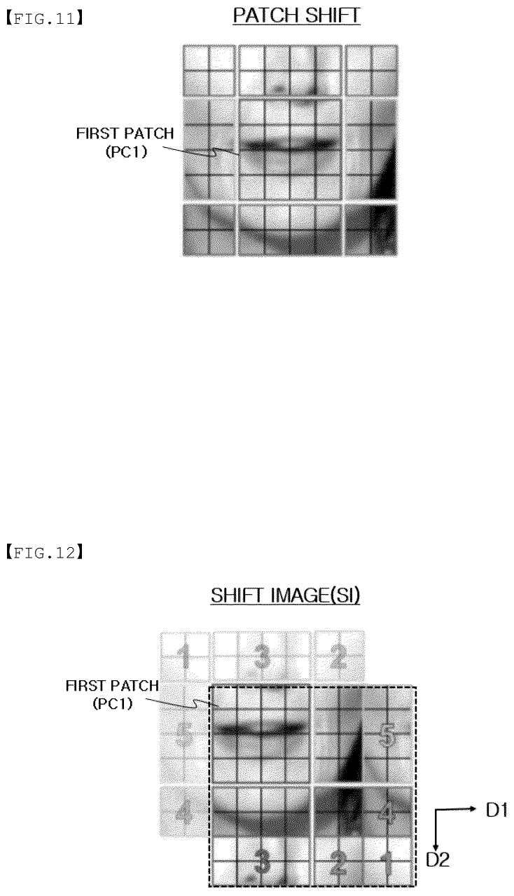

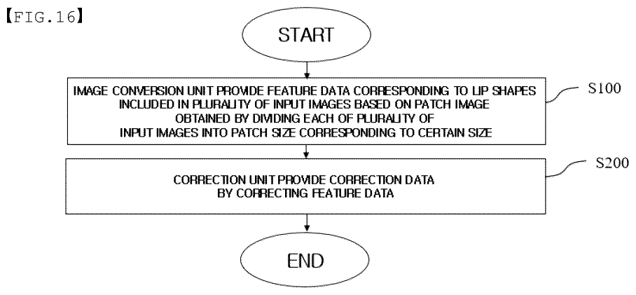

FIGS. 9 to 12 are diagrams for explaining an operation of a data providing unit included in the image processing device of FIG. 1. FIGS. 13 and 14 are diagrams for explaining inputs of the data providing unit included in the image processing device of FIG. 1.

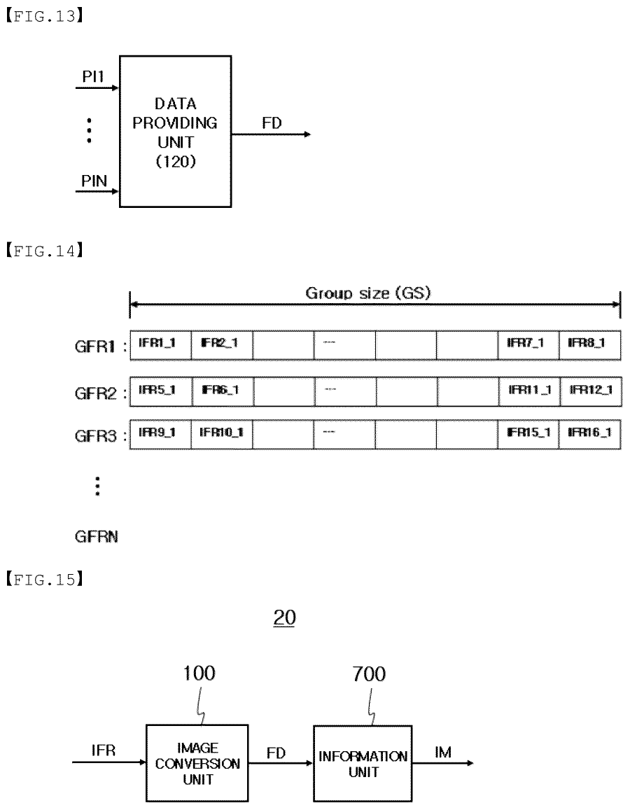

Referring to FIGS. 1 to 14, in an embodiment, a data providing unit 120 may further include a shift unit 121 and a data output unit 122. The shift unit 121 may provide a shift image SI generated by shifting the patch image PI by the unit window WI corresponding to each of the windows WI. For example, a first patch PC1 may be used to derive a first patch image PI1 from an input image. The shift unit 121 may provide the shift image SI while moving in the first direction D1 by the unit window WI by using the first patch PC1. As shown in FIG. 11, the shift image SI may be implemented by arranging a fifth image 5 disposed in the opposite direction to the first direction D1 with respect to the first patch PC1 in the first direction D1 with respect to the first patch PC1, arranging a third image 3 disposed in the opposite direction to a third direction D1 with respect to the first patch PC1 in the third direction with respect to the first patch PC1, and arranging a first image 1, a second image 2, and a fourth image 4 in the same way.

The data output unit 122 may provide the feature data FD based on the shift image SI. Here, an operation of the data output unit 122 may be an operation of a Swin transformer.

In an embodiment, the inputs of the data providing unit 120 may correspond to the patch image PI of each of the plurality of input images IFR.

In another embodiment, the plurality of input images IFR may be grouped by a certain number of the group sizes GSs. The plurality of group images GFRs may overlap by the number of overlaps corresponding to a certain number. The group size GS may be determined based on a length of the utterance voice.

For example, the plurality of input images IFR may include the first input image IFR1 to the sixteenth input image IFR16. In this case, the group size GS may be 8. In this case, a 1_1 input image IFR1_1 to an 8_1 input image IFR8_1 may be input to a first group image GFR1 corresponding to a group of the image providing unit 110, and a 5_1 input image IFR5_1 to a 12_1 input image IFR12_1 may be input to a second group image GFR2 of the image providing unit 110. Also, a 9_1 input image IFR9_1 to a 16_1 input image IFR16_1 may be input to a third group image GFR3 of the image providing unit 110. The same method may also be applied to a second input image to an Nth input image included in the plurality of group images GFR.

In an embodiment, the number of overlaps may be ⅓ or more of the number of the input images IFR input to each of the groups. In another embodiment, the number of overlaps may increase as the number of the plurality of input images IFR increases.

The image processing device 10 according to the present disclosure may more quickly and accurately identify the meaning that a speaker intends to convey by grouping the plurality of input images IFR into bundles of the group size GS corresponding to a certain size and then deriving the feature data FD corresponding to lip shapes included in the plurality of input images IFR based on a patch image obtained by dividing each of the plurality of input images IFR into the patch size PS corresponding to the certain size.

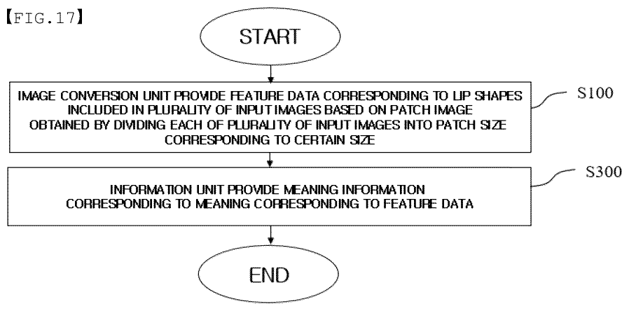

FIG. 15 is a diagram illustrating an image processing system according to embodiments of the present disclosure.

Referring to FIGS. 1 to 15, to solve this problem, an image processing system 20 according to an embodiment of the present disclosure may include an image conversion unit 100 and an information unit 700. The image conversion unit 100 may group the plurality of input images IFR into bundles of the group size GS corresponding to a certain size and then providing the feature data FD corresponding to lip shapes included in the plurality of input images IFR based on a patch image obtained by dividing each of the plurality of input images IFR into the patch size PS corresponding to the certain size. The information unit 700 may provide meaning information IM corresponding to the meaning corresponding to the feature data FD.

FIG. 16 is a flowchart illustrating an operation method of an image processing device according to embodiments of the present disclosure. FIG. 17 is a flowchart illustrating an operation method of an image processing system according to embodiments of the present disclosure.

Referring to FIGS. 1 to 17, to solve this problem, in the operation method of the image processing device 10 according to an embodiment of the present disclosure, the image conversion unit 100 may group the plurality of input images IFR into bundles of the group size GS corresponding to a certain size and then providing the feature data FD corresponding to lip shapes included in the plurality of input images IFR based on a patch image obtained by dividing each of the plurality of input images IFR into the patch size PS corresponding to the certain size (S100). The correction unit 200 may correct the feature data FD to provide the correction data RD (S200).

To solve this problem, in the operation method of the image processing system according to an embodiment of the present disclosure, the image conversion unit 100 may group the plurality of input images IFR into bundles of the group size GS corresponding to a certain size and then providing the feature data FD corresponding to lip shapes included in the plurality of input images IFR based on a patch image obtained by dividing each of the plurality of input images IFR into the patch size PS corresponding to the certain size (S100). The information unit 700 may provide the meaning information IM corresponding to the meaning corresponding to the feature data FD (S300).

The image processing device according to the present disclosure may more accurately identify the meaning that a speaker intends to convey by grouping the plurality of input images IFR into bundles of the group size GS corresponding to a certain size and then deriving the feature data FD corresponding to lip shapes included in the plurality of input images IFR based on a patch image obtained by dividing each of the plurality of input images IFR into the patch size PS corresponding to the certain size.

In addition to the technical problems of the present disclosure mentioned above, other features and advantages of the present disclosure are described below or may be clearly understood by one of ordinary skill in the art to which the present disclosure belongs from such description and explanation.

1. An image processing device comprising:
an image conversion unit configured to provide feature data corresponding to lip shapes included in a plurality of input images based on a patch image obtained by dividing each of the plurality of input images into a patch size corresponding to a certain size; and
a correction unit configured to provide correction data by correcting the feature data.

2. The image processing device of claim 1, wherein the image conversion unit includes
an image providing unit configured to group the plurality of input images as a group size, and then divide each of group images into the patch size to provide the patch image; and
a data providing unit configured to provide the feature data corresponding to the lip shapes based on the patch image.

3. The image processing device of claim 2, wherein the plurality of input image are grouped into bundles of the group size.

4. The image processing device of claim 3, wherein each of the group images overlaps by a number of overlaps corresponding to a certain number.

5. The image processing device of claim 4, wherein the number of overlaps is ⅓ or more of the group size.

6. The image processing device of claim 5, wherein the number of overlaps increases as the number of the plurality of input images increases.

7. The image processing device of claim 2, wherein each of the plurality of input images is divided into a plurality of windows smaller than the patch size.

8. The image processing device of claim 7, further comprising: a lip region detection unit configured to detect a lip region occupied by a lip in each of the plurality of input images.

9. The image processing device of claim 8, further comprising: a window calculating unit configured to calculate the number of the windows corresponding to the lip region of each of the plurality of input images.

10. The image processing device of claim 9, further comprising: a determining unit configured to determine the patch size based on the number of the windows corresponding to the lip region.

11. The image processing device of claim 10, wherein the patch size is determined as a sum of an average value of the number of the windows corresponding to the lip region and half of the average value.

12. The image processing device of claim 11, wherein the data providing unit includes
a shift unit configured to provide a shift image generated by shifting the patch image by a unit window corresponding to each of the windows; and
a data output unit configured to provide the feature data based on the shift image.

13. The image processing device of claim 12, wherein
inputs of the data providing unit are divided into a plurality of patch images, and
each of the plurality of patch images corresponds to the patch image of each of the plurality of input images.

14. An image processing system comprising:
an image conversion unit configured to group each of a plurality of input images into bundles of a certain size and then provide feature data corresponding to lip shapes included in the plurality of input images based on a patch image obtained by dividing each of the plurality of input images into a patch size corresponding to the certain size; and
an information unit configured to provide meaning information corresponding to a meaning corresponding to the feature data.

15. An operation method of an image processing device, the operation method comprising:
grouping, by an image conversion unit, each of a plurality of input images into bundles of a certain size and then provide feature data corresponding to lip shapes included in the plurality of input images based on a patch image obtained by dividing each of the plurality of input images into a patch size corresponding to the certain size; and
providing, by a correction unit, correction data by correcting the feature data.

16. An operation method of an image processing system, the operation method comprising:
grouping, by an image conversion unit, each of a plurality of input images into bundles of a certain size and then provide feature data corresponding to lip shapes included in the plurality of input images based on a patch image obtained by dividing each of the plurality of input images into a patch size corresponding to the certain size; and
providing, by an information unit, meaning information corresponding to a meaning corresponding to the feature data.
